(19) United States
(12) Patent Application Publication
(10) Pub. No.: US 2020/0324512 A1
(43) Pub. Date: Oct. 15, 2020

(54) MULTIFUNCTIONAL WALL COVERING

(71) Applicants: DQCONCEPTS B.V., Voorburg (NL); DUTCHCREEN B.V., Roosedaal (NL)

(72) Inventor: Frederik NOSSBAUM, Voorburg (NL)

(21) Appl. No.: 16/305,398

(22) PCT Filed: May 23, 2017
(86) PCT No.: PCT/NL2017/000005

§ 371 Date: Nov. 29, 2018

(30) Foreign Application Priority Data
May 30, 2016 (NL) 1041891

(51) Int. Cl. B32B 5/24; B32B 5/02; B32B 38/00; B32B 5/18; B32B 7/12; B32B 38/18; B32B 5/26; E04F 13/00

(52) U.S. Cl. CPC B32B 5/245; E04F 2290/045; B32B 38/145; B32B 5/022; B32B 5/18; B32B 7/12; B32B 38/18; B32B 5/26; E04F 13/002; B32B 2262/0253; B32B 2266/0278; B32B 2262/0276; B32B 2307/724; B32B 2307/102; B32B 2607/02; B32B 2307/3065; B32B 2307/72; B32B 2250/03; B32B 2250/02; B32B 2307/75; E04F 2290/041; B32B 5/024

(57) ABSTRACT

The present invention relates to a multifunctional wall covering, a method for manufacture thereof and a method for arranging thereof. The object of the invention is to provide a new wall covering system with which aesthetic properties can be combined in an efficient manner with additional functional properties in general, and more particularly with acoustic properties. The wall covering comprises a strip of material which is longer than it is wide for attachment to wall or partition with at least a first layer and a second layer connected to the first layer which first layer consists of a porous, sound-absorbing textile material, and which second layer consists of an air-permeable textile material and which second layer is provided with a design, which strip of material is at least 2.2 m wide, at least 1.5 mm thick and a maximum of 10 mm thick. The method for manufacturing a multifunctional wall covering is characterized in that the method comprises of providing the strip of material with a design using a known large-format printer or a similar large-format printing system. The method for arranging a strip of the wall covering of the above specified type is characterized in that a wall or partition with a height smaller than or the same as the width of the wall covering is covered seamlessly by the wall covering, whereby an aesthetically high-quality wall covering is realized.

### FIELD OF THE INVENTION

The present invention relates to a multifunctional wall covering, a method for manufacture thereof and a method for arranging thereof. The object of the invention is to provide a new wall covering system with which aesthetic properties can be combined in an efficient manner with additional functional properties in general, and more particularly with acoustic properties.

### BACKGROUND OF THE INVENTION

The term ‘wall covering’ is used below as collective term for coverings attached with an adhesive means in vertical or horizontal strips to walls or partitions of occupied spaces such as living spaces, work spaces and public spaces, with the main object of imparting a decorative appearance to the walls or partitions by means of, among other ways, designs arranged on the wall covering and by means of the texture of the material. Wall coverings were originally manufactured mainly from cellulose in the form of paper. Nowadays other organic and synthetic materials and combinations thereof are applied in addition to cellulose, optionally in a layered configuration and in different qualities, for instance as foam, woven and non-woven. Innovations to wall coverings relate to, among other aspects, measures relating to additional functional properties.

One of these properties relates to the acoustic properties. Acoustic properties determine the extent to which sound waves are absorbed instead of being reflected and transmitted. Multifunctional wall covering refers below in a general sense to wall covering with embodiments of explicit measures for one or more functions in addition to the primary aesthetic function, and more particularly to the sound-absorbing or, in other words, acoustic function.

Summarized in US 20150122399 are the advantages and disadvantages of diverse types of acoustic wall covering. Said document discloses an acoustic wall covering with improved sound-absorbing properties intended to increase comfort. The claimed improved properties are embodied by a wall covering with a layered configuration with an overall thickness of 3.5 to 6 mm. The materials applied are further specified in the document. The measures are explicitly intended to prevent painting of the wall covering, before or after it has been arranged on the wall or partition, resulting in a drastic decrease in the acoustic properties as a result of the decrease in the air-permeability of the top layer facing toward the room. The top layer is provided for this purpose with a glass textile with further specified properties.

Apart from the additional functional properties, there is also a growing demand for more aesthetic as well as unique wall finishes in living, work and public spaces. One of the aesthetic features relates to the finishing of the seams between abutting strips of wall covering. This applies, among other cases, when the design on the respective strips of wall covering must represent a connected whole, such as for instance in the case of photographic images. The use of bright, contrasting colours to produce designs results in higher standards being required for finishing of seams, since seams become more clearly visible in this situation.

In the use of layered types of wall covering, such as of the above stated type with advantageous acoustic properties, it is practically impossible to realize an apparently seamless finish because the porous, sound-absorbing materials applied are not dimensionally stable and consequently vary in thickness. A known method for obviating this problem is to attach the layers with the distinct functions, such as sound-absorbing and decorative respectively, in two successive operations to the wall or partition. An example of such a method is disclosed in WO 2010070367. A drawback of this method is that it is relatively laborious.

The object of the present invention is to provide a new wall covering system with which aesthetic properties can be combined in an efficient manner with additional functional properties in general, and more particularly with acoustic properties.

### SUMMARY OF THE INVENTION

The invention provides for this purpose a multifunctional wall covering, a method for manufacture thereof and a method for arranging thereof on a wall or a partition. The wall covering according to the invention is characterized in that the wall covering comprises a strip of material which is longer than it is wide for attachment to wall or partition, with at least a first layer and a second layer connected to the first layer, which first layer consists of a porous, sound-absorbing textile material, and which second layer consists of an air-permeable textile material and which second layer is provided with a design, which strip of material is at least 2.2 m wide, at least 1.5 mm thick and a maximum of 10 mm thick. A type of wall covering with such properties creates possibilities for providing one or more walls or partitions of an occupied space of a standard height in an advantageous manner with a wall covering with high-quality aesthetic properties and with acoustic properties perceived as pleasant.

The first layer of the wall covering type according to the invention is manufactured from a known, relatively expensive and durable textile material such as a non-woven textile material with acoustic properties, a textile material on the basis of polypropylene or low-density polyethylene, a woven or thermally bonded non-woven textile of polypropylene or a foam material with acoustic properties such as polyurethane. An additional functional property is obtained with an exemplary embodiment of the wall covering of the present type wherein the first layer is characterized by a treatment with a flame-retardant substance.

One of the embodiments of the wall covering type according to the invention is characterized in that the first layer is provided with an adhesive layer for attaching the wall covering to wall or partition, which adhesive layer is provided with a protective sheet. Such an embodiment is advantageous in those situations wherein it is useful to minimize the work time necessary for arranging the wall covering.

The wall covering according to the invention is further characterized in that the second layer is manufactured from a printable textile material such as a woven textile on 100% polyester basis. The application of material types with such properties opens up possibilities for the use of state-of-the-art printing techniques for arranging aesthetically high-quality and unique designs on the wall covering. The invention also provides an embodiment wherein the second layer is provided with a design produced by a large-format printer or printing system. When the design comprises figurative elements, these are oriented spatially according to the invention in relation to a long side of the wall covering.

An additional functional property is obtained with an exemplary embodiment of the wall covering of the present type wherein the second layer is characterized by a treatment with a flame-retardant substance or wherein the first layer and the second layer are mutually connected with a glue layer with flame-retardant properties,

One of the embodiments of the wall covering type according to the invention is characterized in that the wall covering comprises a third layer which is located between the first and the second layer and which is connected thereto and which is manufactured from a non-woven polypropylene textile fabric with a density of 20-100 gf/m². The extra layer between the first and second layers contributes toward evening out possible irregularities on the surface of the first layer, and thereby enhances the aesthetic value of the wall covering.

The method for manufacturing the wall covering according to the present invention comprises of providing a strip of material of the above specified type with a design using a known large-format printer or similar large-format printing system. Providing the acoustic wall covering with a design in such a way is relatively advantageous, aesthetically and qualitatively high-grade and provides possibilities for arranging the wall covering in a cost-effective manner on a wall or partition.

According to an exemplary embodiment of the invention, the method comprises of winding the strip of material provided with a design by the large-format printing technique onto a roll, wherein the side provided with a design is oriented inward and wherein it is possible to preselect whether the strip of material, given the preferred orientation of the design, is rolled up from left to right or vice versa. This feature takes account of the wish to arrange a wall covering of the present type as desired from right to left or the other way round.

According to another exemplary embodiment of the invention, the method makes provision that the strip of material, after being provided with a design and before being wound onto a roll, is folded at least once in the longitudinal direction. The height of the roll of wall covering is reduced by this operation, whereby arranging of a strip on a wall or partition is made easier.

The method for arranging a strip of the wall covering of the above specified type is characterized in that a wall or partition with a height smaller than or the same as the width of the wall covering is covered seamlessly by the wall covering, whereby an aesthetically high-quality wall covering is realized.

The arranging method is further characterized by unwinding the wall covering in rolled-up state along the wall or partition, wherein the roll of wall covering is placed rotatably about an axis of rotation on a mobile platform which is moved for this purpose on the floor along the wall or partition. Such a method facilitates arranging of the wall covering. The method further makes provision that the direction of unrolling of the roll of wall covering, given the preferred orientation of the design, is adapted to the operating direction during arranging of the wall covering.

In order to facilitate arranging of the wall covering according to the invention, a particular aspect of the method makes provision for arranging on the wall or partition a layer provided with hook and loop fastenings for releasable attachment of the wall covering. Another aspect of the method comprises of arranging the wall covering on the wall or partition by making use of the adhesive layer with which the first layer of the wall covering is provided.

### Exemplary Embodiments and Methods According to the Invention

In the simplest embodiment the multifunctional wall covering consists, with the emphasis here on acoustic and aesthetic functions, of a strip which is longer than it is wide and which is assembled from two layers of textile material. The first layer, which is brought into contact with the wall or partition during arranging of the wall covering, is manufactured from a known woven, non-woven or foam material with proven positive acoustic properties. Examples of such materials are textile material on the basis of polypropylene or low-density polyethylene, a woven or thermally bonded non-woven textile of polypropylene and a foam material with acoustic properties, such as polyurethane. The thickness of this first layer measures 1.5 to 10 mm, depending on, among other factors, the desired acoustic properties. In addition to absorbing sounds in the occupied space, the first layer serves to level out surface unevenness of the wall or partition.

The second layer connected to the first layer has printability as most important property. An example of such a textile material is a woven textile on 100% polyester basis. The second layer is air-permeable in order to facilitate the sound-absorbing properties of the first layer.

In a second exemplary embodiment the multifunctional wall covering according to the invention is assembled from three mutually connected layers. The third layer, which lies between the above stated first and second layers, serves substantially to mask surface unevenness of the first layer, whereby the wall covering acquires a smoother appearance. For the purpose of additional functions the respective layers of the wall covering according to the invention can have undergone a flame-retardant treatment. With the same purpose flame-retardant adhesives can be applied to mutually connect the respective layers.

The second layer can also be provided, on the basis of an additional treatment, with a dirt-repellent layer.

For seamless covering of a wall or partition of an occupied space with a standard height, the width of a strip of wall covering according to the invention is a minimum of 2.20 m, and in principle suitable for printing with a large-format printing system. The length of a strip of wall covering is preferably at least equal to the width of standard occupied spaces so that a wall or partition can be seamlessly covered. In order to arrange wall covering in one horizontal width on the wall or partition, according to the invention designs with figurative elements are spatially oriented relative to a long side.

The method for manufacturing the multifunctional wall covering preferably comprises of arranging a design on the strip of two or more layers by means of a known large-format printing system. A strip of limited length of the wall covering provided with a design is rolled up as desired from left to right or vice versa. The optimal direction depends on the preferred direction during covering of a wall or partition. In order to facilitate arranging of a strip of wall covering which is wider than the height of the occupied space the strip of wall covering, after being provided with a design, can be rolled up with one or more folds.

For arranging the wall covering according to invention it is efficient to make use of a tool, which is not further specified here and which comprises a mobile platform on which a roll of wall covering is placed for rotation around a shaft and with which the roll is unrolled along the wall or partition to be covered.

The arranging of the wall covering on a wall or partition preferably takes place in some situations by making use of a glue which is applied to the wall or partition. In a particular embodiment the first layer is provided with an adhesive layer with a protective sheet. For special situations the invention makes provision for arranging on the wall or partition a layer or a strip with hook and loop fastenings with which the woven or non-woven first layer can be attached, temporarily or otherwise, to the wall.

1. Multifunctional wall covering, method for manufacture thereof and method for arranging thereof on a wall or a partition, characterized in that the wall covering comprises a strip of material which is longer than it is wide for attachment to wall or partition, with at least a first layer and a second layer connected to the first layer, which first layer consists of a porous, sound-absorbing textile material, and which second layer consists of an air-permeable textile material and which second layer is provided with a design, which strip of material is at least 2.2 m wide, at least 1.5 mm thick and a maximum of 10 mm thick.

2. Multifunctional wall covering as claimed in claim 1, characterized in that the first layer is manufactured from a non-woven textile material with acoustic properties, such as a textile material on the basis of polypropylene or low-density polyethylene.

3. Multifunctional wall covering as claimed in claim 1 , characterized in that the first layer is manufactured from a woven or non-woven textile material with acoustic properties, such as a woven or thermally bonded non-woven textile of polypropylene.

4. Multifunctional wall covering as claimed in claim 1 , characterized in that the first layer is manufactured from a foam material with acoustic properties such as
polyurethane.

5. Multifunctional wall covering as claimed in claim 1, characterized in that the first layer is manufactured from a textile with flame-retardant properties due to a treatment with a flame-retardant substance.

6. Multifunctional wall covering as claimed in claim 1, characterized in that the first layer is provided with an adhesive layer for attaching the wall covering to wall or partition, which adhesive layer is provided with a protective sheet

7. Multifunctional wall covering as claimed in claim 1, characterized in that the second layer is manufactured from a printable textile material such as a woven textile on 100% polyester basis.

8. Multifunctional wall covering as claimed in claim 1, characterized in that the second layer is provided with a design produced by a large-format printer or printing system.

9. Multifunctional wall covering as claimed in claim 1, characterized in that the second layer is manufactured from a textile with flame-retardant properties due to a treatment with a flame-retardant substance.

10. Multifunctional wall covering as claimed in claim 1, characterized in that the design comprises figurative elements which are oriented spatially in relation to a long side.

11. Multifunctional wall covering as claimed in claim 1, characterized in that the first layer and the second layer are mutually connected with a glue layer with flame-retardant properties.

12. Multifunctional wall covering as claimed in claim 1, characterized in that the wall covering comprises a third layer which is located between the first and the second layer and which is connected thereto and which is manufactured from a non-woven polypropylene textile fabric with a density of 20-100 gf/m2.

13. Method for manufacturing a multifunctional wall covering of the type as claimed in claim 1, characterized in that the method comprises of providing the strip of material with a design using a known large-format printer or a similar large-format printing system.

14. Method as claimed in claim 13, characterized in that the method comprises of winding the strip of material provided with a design by the large-format printing technique onto a roll, wherein the side provided with a design is oriented inward and wherein it is possible to preselect whether the strip of material, given the preferred orientation of the design, is rolled up from left to right or vice versa.

15. Method as claimed in claim 13, characterized in that the method makes provision that the strip of material, after being provided with a design and before being wound onto a roll, is folded at least once in the longitudinal direction.

16. Method for arranging a multifunctional wall covering of the type as claimed in claim 1 on a wall or partition, characterized in that a wall or partition with a height smaller than or the same as the width of the wall covering is covered seamlessly by the wall covering.

17. Method as claimed in claim 16, characterized in that the method comprises of unwinding the wall covering in rolled-up state along the wall or partition, wherein the roll of wall covering is placed rotatably about an axis of rotation on a mobile platform which is moved for this purpose on the floor along the wall or partition.

18. Method as claimed in claim 16, characterized in that the method makes provision that the direction of unrolling of the roll of wall covering, given the preferred orientation of the design, is adapted to the operating direction during arranging of the wall covering.

19. Method as claimed in claim 16, characterized in that the method comprises of arranging on the wall or partition a layer provided with hook and loop
fastenings for releasable attachment of the wall covering.

20. Method as claimed in claim 16, characterized in that the method comprises of arranging the wall covering on the wall or partition by making use of the adhesive layer for attaching the wall covering to wall or partition, which adhesive layer is provided with a protective sheet.
